(19) United States
(12) Patent Application Publication
(10) Pub. No.: US 2007/0092640 A1
(43) Pub. Date: Apr. 26, 2007

(54) Process for applying organophosphorus-based layers on substrates

(76) Inventors: Eric L. Bruner, San Diego, CA (US); Eric L. Hanson, San Diego, CA (US); Gerald W. Gruber, Englewood, FL (US)

Correspondence Address: William J. Uhl, 4110 Devonwood Court, Murrysville, PA, 15668, US

(21) Appl. No.: 11/585,489

(22) Filed: Oct. 24, 2006

Related U.S. Application Data
(60) Provisional application No. 60/729,633, filed on Oct. 24, 2005.

(51) Int. Cl. B05D 3/02; D06L 3/12; B05B 5/00

(52) U.S. Cl. 427/157; 427/372.2

(57) ABSTRACT

A process for applying an organophosphorus-based layer on a substrate, utilizing a solution of an at least partially amine-neutralized organophosphorus acid, is disclosed.

### CROSS REFERENCE TO RELATED APPLICATION

The present application claims priority from U.S. Provisional Patent Application Ser. No. 60/729,633, filed Oct. 24, 2005.

### FIELD OF THE INVENTION

The present invention relates to the application of organophosphorus-based layers to substrates, and more particularly, relates to such a process using solutions of amine salts of organophosphorus acids.

### BACKGROUND OF THE INVENTION

Self-assembled films or layers on various substrates are well known in the art. These films or layers typically have functional groups (head groups) that bond to a cofunctional group on the substrate surface and organo groups (tail groups) that have some mutual attraction to neighboring molecules in the layer(s) or to the surface. These self-assembled films are used in various applications such as medical and electronic applications. In medical applications, they are typically used to form an interfacial layer between a titanium orthopedic implant and the surrounding body tissue. In electrical applications, the self-assembled films are useful for improving the performance of devices that incorporate organic-inorganic interfaces such as are found in organic light-emitting diodes.

An example of a self-assembled film is disclosed in U.S. Published Application No. 2004/0001959 A1. The film is an organophosphorus film that is deposited from an organophosphorus acid onto a metal substrate. The substrate on which the film is deposited has oxide groups on the surface that are reactive with the acid groups of the organophosphorus compound. The organo group orients out and away from the surface and acts to modify the physical properties of the substrate. The organo group can also contain a functional group that is reactive with other functional groups such as those associated with the subsequently applied coating to modify further the properties of the substrate surface. In this regard, see U.S. Published Application No. 2004/0023048 A1.

For the most part, the organophosphorus acids are applied to the substrate surface as a solution in an organic solvent or as a salt of an inorganic base such as sodium or potassium hydroxide. The use of organic solvents presents environmental issues associated with the disposal of such solvents and the use of inorganic bases results in the metal being retained in the resultant film which may be undesirable.

The present invention avoids these difficulties by depositing the organophosphorus acid from a solution of an amine salt or amine complex of the organophosphorus acid. The volatility of the amines vary with structure allowing one to control the amount of amine remaining in the film by selecting the appropriate amine and heating the film at elevated temperature.

### SUMMARY OF THE INVENTION

A process for applying an organophosphorus-based layer on a substrate comprising:
(a) applying directly or indirectly through an intermediate layer to the substrate a solution of an at least partially amine-neutralized organophosphorus acid, and
(b) removing solvent associated with the solution to form a self-assembled structure on the substrate or the intermediate layer.

In another aspect, the invention is directed to a process for applying an organophosphorus-based layer on a substrate comprising:
(a) applying directly or indirectly through an intermediate layer to the substrate a solution of an at least partially amine-neutralized organophosphorus acid, and
(b) removing solvent associated with the solution and bonding organophosphorus acid to the substrate or the intermediate layer.

### DETAILED DESCRIPTION OF THE INVENTION

The organo group of the phosphorus acid may be a monomeric, oligomeric or polymeric group. Examples of monomeric phosphorus acids are phosphoric acids, phosphonic acids and phosphinic acids.

Examples of monomeric phosphoric acids are compounds or a mixture of compounds having the following structure:
(RO)ₓ—P(O)—(OR′)_{y}
wherein x is 1-2, y is 1-2 and x+y=3, R preferably is a radical having a total of 1-30, preferably 6-18 carbons, and R′ is H. The organic component of the phosphoric acid (R) can be aliphatic (e.g., alkyl having 2-20, preferably 6-18 carbon atoms) including an unsaturated carbon chain (e.g., an olefin), or can be aryl or aryl-substituted moiety.

Example of monomeric phosphonic acids are compounds or mixture of compounds having the formula: 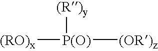
wherein x is 0-1, y is 1, z is 1-2 and x+y+z is 3, R and R″ preferably are each independently a radical having a total of 1-30, preferably 6-18 carbons, and R′ is H. The organic component of the phosphonic acid (R and R″) can be aliphatic (e.g., alkyl having 2-20, preferably 6-18 carbon atoms) including an unsaturated carbon chain (e.g., an olefin), or can be an aryl or aryl-substituted moiety.

Example of monomeric phosphinic acids are compounds or mixture of compounds having the formula: 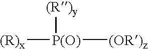
wherein x is 0-2, y is 0-2, z is 1 and x+y+z is 3, R and R″ preferably are each independently radicals having a total of 1-30, preferably 6-18 carbons, R′ is H. The organic component of the phosphinic acid (R, R″) can be aliphatic (e.g., alkyl having 2-20, preferably 6-18 carbon atoms) including an unsaturated carbon chain (e.g., an olefin), or can be an aryl or aryl-substituted moiety.

Examples of organo groups which may comprise R and R″ include long and short chain aliphatic hydrocarbons, aromatic hydrocarbons and substituted aliphatic hydrocarbons and substituted aromatic hydrocarbons. Examples of substituents include carboxyl such as carboxylic acid, hydroxyl, amino, imino, amido, thio, cyano, fluoro such as CF₃(CnF₂ₙ)CH₂CH₂PO₃H₂ where n=3-15, CF₃(CF₂)_{X}O(CF₂CF₂)_{y}—CH₂CH₂—PO₃H₂ where x is 0 to 7, y is 1 to 20 and x+y≦27, phosphonate, phosphinate, sulfonate, carbonate and mixed substituents.

Representative of the organophosphorus acids are as follows: amino trismethylene phosphonic acid, aminobenzylphosphonic acid, 3-amino propyl phosphonic acid, O-aminophenyl phosphonic acid, 4-methoxyphenyl phosphonic acid, aminophenylphosphonic acid, aminophosphonobutyric acid, aminopropylphosphonic acid, benzhydrylphosphonic acid, benzylphosphonic acid, butylphosphonic acid, carboxyethylphosphonic acid, diphenylphosphinic acid, dodecylphosphonic acid, ethylidenediphosphonic acid, heptadecylphosphonic acid, methylbenzylphosphonic acid, naphthylmethylphosphonic acid, octadecylphosphonic acid, octylphosphonic acid, pentylphosphonic acid, phenylphosphinic acid, phenylphosphonic acid, bis(perfluoroheptyl) phosphinic acid, perfluorohexyl phosphonic acid, styrene phosphonic acid, dodecyl bis-1,12-phosphonic acid.

In addition to the monomeric organophosphorus acids, oligomeric or polymeric organophosphorus acids resulting from self-condensation of the respective monomeric acids may be used.

The organophosphorus acid is at least partially neutralized with an amine to form an amine salt. The amount of amine that is reacted with the organophosphorus acid should be sufficient to solubilize the organophosphorus acid. Typically, the equivalent ratio of amine to organophosphorus acid is in the range of 0.1 to 3.0, preferably 0.5 to 1.0, the amine being considered monofunctional and the equivalents of organophosphorus acid being determined by the equivalents of acid groups or derivatives thereof. Although the amine salt is or is referred to as being solubilized in solution, emulsions and dispersions are also meant by the term “solution”.

The selection of the amine depends upon the application involved and can vary from volatile amines with relatively high vapor pressures, which are released from the film on heating, to essentially non-volatile amines with relatively low vapor pressures, which remain at least in part in the film.

Examples of the volatile amines are primary, secondary and tertiary amines having a boiling point below 200° C. Non-limiting examples of such amines include propylamine, diethylamine and dimethylamine.

Examples of non-volatile amines are primary, secondary and tertiary amines having boiling points of at least 200° C. Non-limiting examples of such amines include ethanolamine, diethanolamine, triethanolamine, methyl ethanolamine, dodecylamine, diamylamine and oleyl amine. Alkanol amines are preferred. Mixtures of volatile and non-volatile amines can conveniently be used to improve coating properties.

The solvent or diluent for the amine salt is preferably water, although it can also be a protic solvent such as ethanol or propanol. Usually, the solvent or diluent will be an aqueous medium that includes water and an organic diluent. Useful organic diluents include hydrocarbons, alcohols, esters, ethers and ketones. Specific coalescing diluents include hexane, isooctane and decane, methanol, ethanol, isopropanol, butanol, 2-ethylhexanol, methyl ethyl ketone, isophorone, 2-methoxypentanone, ethylene and propylene glycol and glycol ethers such as the monohexyl ethers of ethylene glycol, tetrahydrofuran and diethyl ether. The amount of the organic diluent is generally between about 0.01 and 25 percent and when used, preferably from about 0.05 to about 5 percent by weight based on total weight of the aqueous medium.

Adjuvant materials may be present with the amine salt or amine complex and the diluent (organophosphorus compositions). Examples include surface active agents, wetting agents and anti-static agents. The adjuvant if present is present in amounts of up to 30 percent by weight based on the non-volatile content of the organophosphorus acid composition.

The concentration of the amine salt or amine complex of the organophosphorus acid in the composition can be adjusted within wide ranges to meet the requirements of the application on end use. Concentrations typically are at least 0.01 millimolar, usually 0.01 to 100 millimolar, and more typically 0.1 to 50 millimolar. The organophosphorus acid composition can be prepared by mixing all of the components at the same time or by adding the components in several steps.

Examples of suitable surfaces or substrates treated by the process of the present invention include planar and irregular shaped substrates as well as substrates in particulate form. The substrate may comprise metals such as aluminum, copper, titanium and iron, and alloys of metals such as steel and brass; metalloids such as silicon and germanium, ceramic materials such as glass, including fiber glass, and polymer materials such as polycarbonates and epoxies and woven and non-woven fabric and cloth. Preferably, the substrate is one that contains surface hydroxyls or oxide groups such as the native oxide layers associated with most metals and their alloys. Native oxide layers of metalloids such as silicon are also appropriate. Surface-modified ceramic materials and surface-modified polymer may also be used. For example, a metal oxide layer may be applied to a glass or plastic substrate by sputtering, or a silicon oxide overlayer may be provided by applying a sol-gel to the substrate. Indium tin oxide is a metal oxide preferred for electrical end use applications and may be applied by sputtering. Polymer substrates that have reactive functional groups such as polymers containing hydroxyl groups can also be used. Examples of such polymers include acrylic polymers prepared from one or more monomers containing hydroxyl groups. Also, composite inorganic/organic polymers such as organo polymers containing entrained silica and/or alumina may be used. Also, polymer surfaces may be oxidized by subjecting them to an atmospheric plasma treatment in the presence of air.

Specific substrates are optical or electrooptical surfaces such as those associated with eyewear, camera lenses and display devices such as those associated with light-emitting diodes including organic light-emitting diodes, polymer light-emitting diodes, liquid crystals and plasma screens. These substrates may optionally have an anti-reflective layer usually comprising a series of films sequentially deposited on one another, for example, alternating layers of silica and indium tin oxide.

The solution of the amine salt of the organophosphorus acid may be applied to the surface of the substrate by many ways such as immersion coating (dipping), spraying or through the use of a carrier such as a roll coater, wiping cloth, etc. With such applications, the solution can coalesce on the substrate to form a substantially continuous film.

The solution can also be applied to the substrate in a discontinuous film or in the form of a pattern. For example, the solution can be applied by stenciling, stamping, screen printing, ink-jet printing, gravure printing and lithography.

Irregardless of how the solution has been applied to the substrate, that is, as a substantially continuous or discontinuous film, energy in the form of light or heat is then applied to the coated substrate to remove the solvent or diluent, optionally amine, and to bond the organophosphorus acid to the substrate.

Although not intending to be bound by any theory, it is believed that the acid end of the organophosphorus acid associates and possibly reacts with the oxide and/or the hydroxyl groups associated with the surface of the substrate. Depending on the identity of the surface group, association or reaction can occur at room temperature, i.e., 200° C., or at elevated temperature, typically at lower temperatures vacuum may be used to assist in solvent and amine removal. Temperatures of from 50 to 200° C., usually 100 to 150° C., from 5 seconds to 3 hours, usually 2 to 180 seconds are sufficient. Heating by thermal means, by light (e.g., infrared, microwave, etc.) can be used.

The organophosphorus acid forms a self-assembled structure, typically in film form, on the surface of the substrate, namely, as mentioned above, the acid group is associated with or may even be bonded to the surface of the substrate and the organo group orients out and away from the substrate. Depending upon the concentration of the organophosphorus acid in the solution, the self-assembled layer may be as thin as a monolayer or as a multilayer coating.

The organophosphorus layer may be applied directly to the substrate or it may be applied indirectly through an intermediate layer. For example, the substrate can first be coated with an organometallic compound such as a metal alkoxide followed by overcoating with the organophosphorus acid. See, for example, U.S. Pat. No. 6,645,644. It is believed the organometallic layer is bonded to the substrate surface and the organophosphorus layer is associated with and in some cases bonded to the organometallic layer. Examples of metal alkoxides are those based on metals such as aluminum and transition metals such as tantalum, titanium and zirconium in which the alkoxide group contains 1 to 18, preferably 2 to 8 carbon atoms, such as ethoxide, isopropoxide and tert-butoxide. Mixed groups comprising alkoxide and chloride groups may also be used.

Whereas particular embodiments of this invention have been described above for purposes of illustration, it will be evident to those skilled in the art that numerous variations of the details of the present invention may be made without departing from the invention as defined in the following claims.

What is claimed is:

1. A process for applying an organophosphorus layer on a substrate comprising:
(a) applying directly or indirectly through an intermediate layer to the substrate a solution of an at least partially amine-neutralized organophosphorus acid, and
(b) removing solvent associated with the solution and bonding the organophosphorus acid to the substrate or to the intermediate layer.

2. The process of claim 1 in which a film of the at least partially amine-neutralized organophosphorus acid is formed on the substrate or intermediate layer.

3. The process of claim 1 in which the solution is based on a protic solvent.

4. The process of claim 3 in which the protic solvent comprises water.

5. The process of claim 1 in which at least a portion of the amine is removed with the solvent.

6. The process of claim 1 in which the amine has a boiling point at ambient conditions of pressure of at least 200° C.

7. The process of claim 1 in which the amine has a boiling point at ambient conditions of pressure of less than 200° C.

8. The process of claim 1 in which the amine is selected from alkyl amines and alkanol amines.

9. The process of claim 2 in which heat energy is applied to the film.

10. The process of claim 9 in which the heat energy is applied by heating to at least 80° C.

11. The process of claim 1 in which the surface of the substrate has functional groups that are reactive with the acid groups of the organophosphorus acid.

12. The process of claim 11 in which the acid groups of the organophosphorus acid form a covalent bond with the functional groups of the substrate.

13. The process of claim 11 in which the functional groups are selected from oxide groups and hydroxyl groups.

14. The process of claim 1 in which the aqueous solution has a concentration of at least 0.01 millimolar.

15. The process of claim 1 in which the organophosphorus acid is selected from a phosphoric acid, a phosphonic acid or a phosphinic acid.

16. The process of claim 15 in which the organophosphorus acid is an organophosphoric acid of the structure:
(RO)ₓ—P(O)—(OR′)_{y}
wherein x is 1 to 2, y is 1 to 2 and x+y=3, R is a radical having a total of 1 to 30 carbons and R′ is H.

17. The process of claim 15 in which the organophosphorus acid is an organophosphonic acid of the structure: 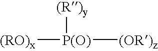
wherein x is 0 to 1, y is 1, z is 1 to 2 and x+y+z=3, R and R″ are each independently a hydrocarbon or substituted hydrocarbon radical having a total of 1 to 30 carbon atoms and R′ is H.

18. The process of claim 15 in which the organophosphorus acid is an organophosphinic acid of the structure: 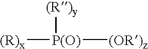
wherein x is 0 to 2, y is 0 to 2, z is 1 and x+y+z=3, R and R″ are each independently a hydrocarbon or substituted hydrocarbon radical having a total of 1 to 30 carbons and R′ is H.

19. The process of claim 1 in which the intermediate layer is derived from an organometallic compound.

20. The process of claim 19 in which the organometallic compound is a transition metal alkoxide.

21. The process of claim 20 in which the transition metal is selected from titanium and zirconium.

22. A process for applying an organophosphorus layer on a substrate comprising:
(a) applying directly or indirectly through an intermediate layer to the substrate a solution of an at least partially amine-neutralized organophosphorus acid, and
(b) removing solvent associated with the solution so as to form a self-assembled structure on the substrate surface or the intermediate layer.

23. The process of claim 22 in which the self-assembled structure is a self-assembled layer.

24. The process of claim 23 in which the self-assembled layer is a monolayer.

25. The process of claim 22 in which the organophosphorus acid is selected from a phosphoric acid, a phosphonic acid or a phosphinic acid.

26. The process of claim 22 in which the organophosphorus acid is an organophosphoric acid of the structure:
(RO)ₓ—P(O)—(OR′)_{y}
wherein x is 1 to 2, y is 1 to 2 and x+y=3, R is a radical having a total of 1 to 30 carbons and R′ is H.

27. The process of claim 22 in which the organophosphorus acid is an organophosphonic acid of the structure: 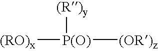
wherein x is 0 to 1, y is 1, z is 1 to 2 and x+y+z=3, R and R″ are each independently a hydrocarbon or substituted hydrocarbon radical having a total of 1 to 30 carbon atoms and R′ is H.

28. The process of claim 22 in which the organophosphorus acid is an organophosphinic acid of the structure: 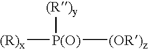
wherein x is 0 to 2, y is 0 to 2, z is 1 and x+y+z=3, R and R″ are each independently a hydrocarbon or substituted hydrocarbon radical having a total of 1 to 30 carbons and R′ is H.

29. The process of claim 22 in which the intermediate layer is derived from an organometallic compound.

30. The process of claim 29 in which the organometallic compound is a transition metal alkoxide.

31. The process of claim 30 in which the transition metal is selected from titanium and zirconium.
